(19) United States
(12) Patent Application Publication
(10) Pub. No.: US 2002/0033473 A1
(43) Pub. Date: Mar. 21, 2002

(54) Liquid crystalline medium

(75) Inventors: Michael Heckmeier, Bensheim (DE); Peer Kirsch, Darmstadt (DE); Matthias Bremer, Darmstadt (DE); Detlef Pauluth, Ober-Ramstadt (DE); Sabine Schoen, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GESELLSCHAFT MIT, Darmstadt (DE)

(21) Appl. No.: 09/863,907

(22) Filed: May 24, 2001

(30) Foreign Application Priority Data
May 25, 2000 (DE) 100 25 884.0

(51) Int. Cl. C09K 19/30; C09K 19/34; C09K 19/20; C09K 19/32

(52) U.S. Cl. 252/299.63; 252/299.61; 252/299.62; 252/299.67; 428/1.1

(57) ABSTRACT

The invention relates to a liquid-crystalline medium of positive dielectric anisotropy which comprises at least one mesogenic compound and at least one compound of the formula I

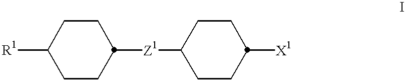

in which the substituents are as defined herein.

The invention relates to a liquid-crystalline medium and to an electro-optical liquid-crystal display containing this medium, and in particular to a liquid-crystal display having a realignment layer, for realigning the liquid crystals, whose field has a component parallel to the liquid-crystal layer which is crucial for the realignment. The liquid-crystalline medium has a positive dielectric anisotropy and comprises at least one mesogenic compound of the formula I

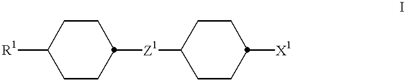

in which

R¹ is alkyl or alkoxy having 1 to 7 carbon atoms, preferably having 1 to 5 carbon atoms, or alkenyl, alkenyloxy or alkoxyalkyl having 2 to 7 carbon atoms, preferably having 2 to 5 carbon atoms,

Z¹ is CF₂—CF₂, CF₂—O, CH₂—CH₂, trans-CH═CH, trans-CF═CH, trans-CH═CF or trans-CF═CF, preferably CF₂—CF₂ or CF₂—O, particularly preferably CF₂—CF₂, and

X¹ is F, Cl, CF₃, OCF₃, OCF₂H, CN or NCS, preferably CN.

In conventional liquid-crystal displays (TN, STN, OMI AMD-TN), the electric fields for the realignment are generated essentially perpendicular to the liquid-crystal layer.

International Patent Application WO 91/10936 discloses a liquid-crystal display in which the electric signals are generated in such a way that the electric fields have a significant component parallel to the liquid-crystal layer (IPS, in-plane switching). The principles of operation of a display of this type are described, for example, by R. A. Soref in Journal of Applied Physics, Vol. 45, No. 12, pp. 5466-5468 (1974).

For example, EP 0 588 568 discloses various possibilities for designing the electrodes and for addressing a display of this type. DE 198 24 137 likewise describes various embodiments of IPS displays of this type.

Liquid-crystalline materials for use in IPS displays of this type are described, for example, in DE 198 48 181.

IPS displays containing the known liquid-crystalline media are characterized by inadequately long response times and often by excessively high operating voltages. There is thus a need for IPS displays which do not have these disadvantages, or only do so to a reduced extent. Liquid-crystalline materials required for this purpose are in particular those which, in addition to an adequate phase range, a low crystallization tendency at low temperatures, a low birefringence and an adequate electrical resistance, in particular have low threshold voltages (V₁₀) and low rotational viiscosities (γ₁) which are crucial for the response times.

Surprisingly, this object has been achieved by using liquid-crystalline materials which comprise at least one compound of the formula I.

The liquid-crystal media according to the invention are notable for their relatively high clearing points, their low rotational viscosities and their low thresholds.

The invention thus relates to liquid-crystalline media of positive dielectric anisotropy which comprise at least one compound of the formula I and which are very suitable for an electro-optical liquid-crystal display having a realignment layer, for realigning the liquid crystals, whose field has a significant component parallel to the liquid-crystal layer, and to displays of this type.

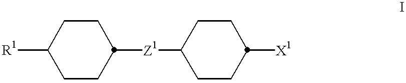

in which

R¹ is alkyl or alkoxy having 1 to 7 carbon atoms, preferaby n-alkyl or n-alkoxy, particularly preferably having 1 to 5 carbon atoms, or alkenyl, alkenyloxy or alkoxyalkyl having 2 to 7 carbon atoms, preferably 1E-alkenyl, 1E-alkenyloxy or straight-chain alkoxyalkyl, particularly preferably having 2 to 5 carbon atoms,

Z¹ is CF₂—CF₂, CF₂—O, CH₂—CH₂, trans-CH═CH, trans-CF═CH, trans-CH═CF or trans-CF═CF, preferably CF₂—CF₂ or CF₂—O, particularly preferably CF₂—CF₂, and

X¹ is F, Cl, CF₃, OCF₃, OCF₂H, CN or NCS, preferably CN.

Particular preference is given to liquid-crystal media which comprise at least one compound of the formula I in which Z¹ is CF₂—CF₂. Very particular preference is given to such liquid-crystal media which comprise at least one compound of the formula I in which Z¹ is CF₂—CF₂ and X¹ is CN.

The liquid-crystal media preferably comprise at least one compound selected from the group consisting of the compounds of the formulae I-1a to I-1e and/or I-2a to I-2e

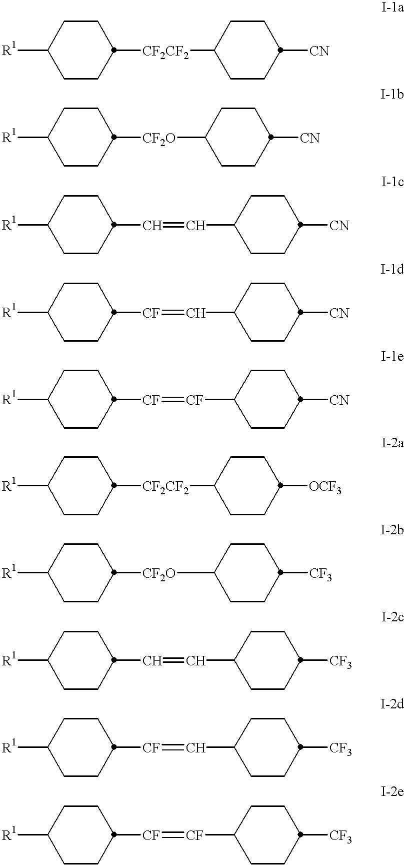

Particular preference is given here to compounds selected from the group consisting of the compounds of the subformulae I-1a, I-1b, I-2a and I-2b, very particularly preferably of the subformulae I-1a and I-2a.

Preference is furthermore given to liquid-crystal media which comprise one or more compound(s) of the formula II

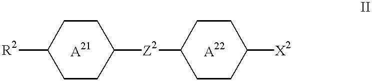

in which

R² is alkyl or alkoxy having 1 to 7 carbon atoms or alkenyl, alkenyloxy or alkoxyalkyl having 2 to 7 carbon atoms,

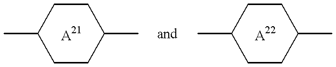

are each, independently of one another,

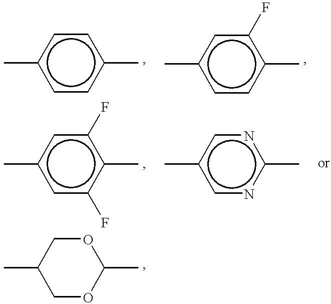

X² is F, Cl, CN or NCS, preferably CN or NCS, particularly preferably CN, and

Z² is CH₂CH₂, COO, CF₂O or a single bond.

A preferred subformula of the formula II is the formula II-1

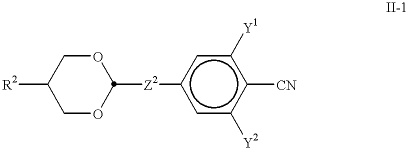

in which the parameters are as defined above under the formula II.

Particular preference is given to compounds of the formula II in which

Z² is a single bond,

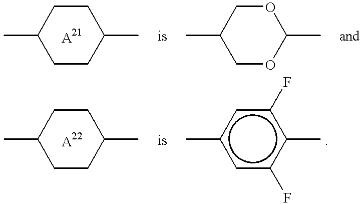

Preference is furthermore given to compounds of the formula II in which

Z² is a single bond,

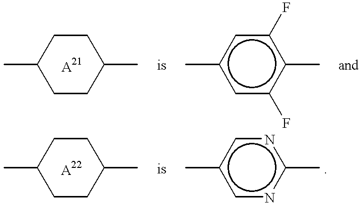

Preference is furthermore given to compounds of the formula II in which X² is CN.

Preference is furthermore given to liquid-crystal media which comprise one or more compound(s) of the formula III

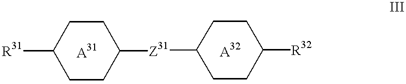

in which

R³¹ and R³² are each, independently of one another, alkyl or alkoxy having 1 to 7 carbon atoms or alkenyl, alkenyloxy or alkoxyalkyl having 2 to 7 carbon atoms,

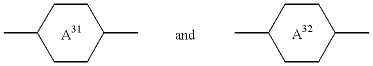

are each, independently of one another,

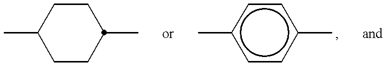

Z³¹ is CH═CH, COO, CH₂CH₂ or a single bond.

Particular preference is given to liquid-crystal media which comprise one or more compound(s) of the formula III in which

at least one of

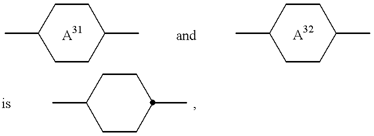

particularly preferably both are

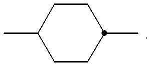

Preference is furthermore given to media comprising compounds of the formula III in which at least one of the radicals R³¹ und R³² is alkenyl having 2 to 7 carbon atoms, preferably having 2 or 3 carbon atoms.

Preference is furthermore given to media which comprise one or more compound(s) of the formula III, in which Z³¹ is CH═CH or a single bond, particularly preferably a single bond.

Preference is furthermore given to liquid-crystal media which comprise one or more compound(s) of the formula IV

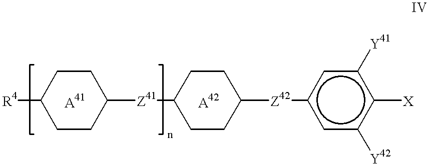

in which

R⁴ is alkyl or alkoxy having 1 to 7 carbon atoms or alkenyl, alkenyloxy or alkoxyalkyl having 2 to 7 carbon atoms,

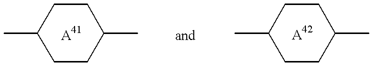

are each, independently of one another,

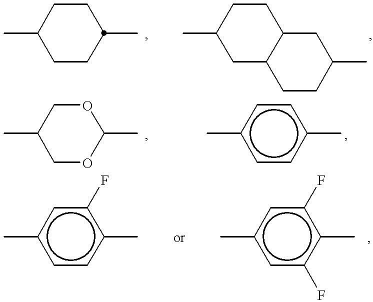

Z⁴¹ and Z⁴² are each, independently of one another, CF₂O, COO, CH₂CH₂, trans-CF═CF, trans-CH═CH, trans-CF═CH, trans-CH═CF or a single bond,

n is 0 or 1,

X is fluorinated alkyl or alkoxy or halogen, preferably OCF₃, OCF₂H or F, and

Y⁴¹ and Y⁴² are each, independently of one another, H or F.

Preferred subformulae of the formula IV are the formulae IV-1 and IV-2

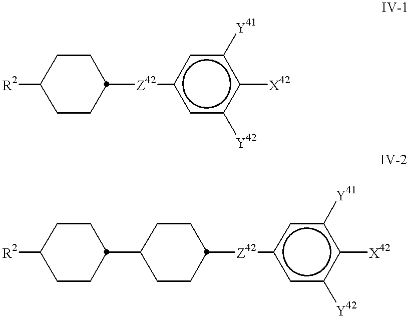

in which the parameters are as defined above under formula IV, and preferably X⁴² is F and, in formula IV-1, Y⁴¹ and Y⁴² are H and Z⁴² is CH₂CH₂ or a single bond, preferably a single bond, and, in formula IV-2, Y⁴¹ and Y⁴² are F and Z⁴² is COO or a single bond.

The media particularly preferably comprise one or more compound(s) of the formula IV in which at least one of

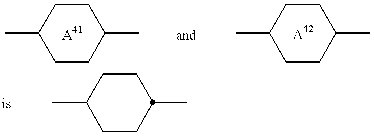

and, if present, preferably both are

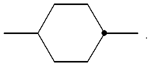

Preference is furthermore given to media which comprise one or more compound(s) of the formula IV in which Z⁴¹ and Z⁴² are each, independently of one another, CH₂CH₂ or a single bond.

Preference is furthermore given to media which comprise one or more compounds of the formula IV in which X is OCF₃ and Y⁴¹ and Y⁴² are H, and one or more compound(s) of the formula IV in which X, Y⁴¹ and Y⁴² are F.

Particular preference is given to media which comprise at least one compound of the formula I, at least one compound of the formula II and at least one compound of the formula III.

Particular preference is given to liquid-crystal media which comprise one or more compound(s) of the formula II selected from the group consisting of the subformulae IIa to IIf and/or IIg to IIi.

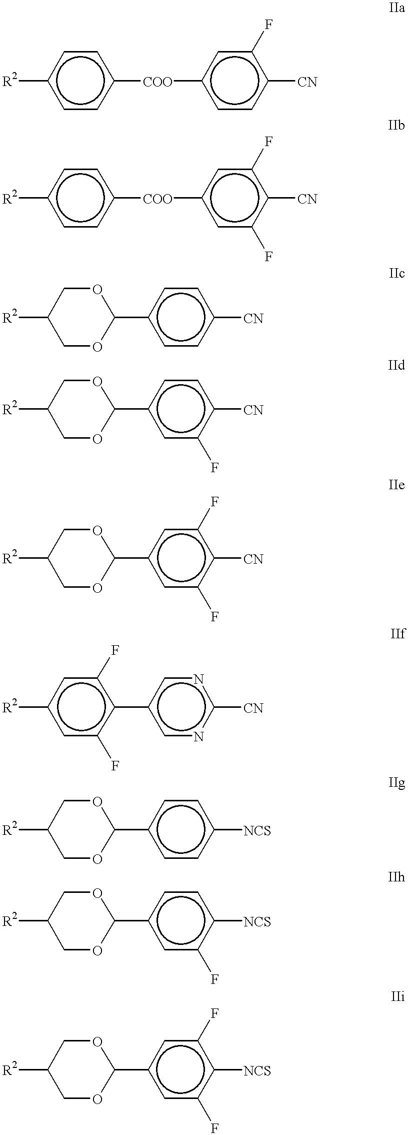

in which R² is as defined above under formula II.

The liquid-crystal medium particularly preferably comprises one or more compound(s) selected from the group consisting of the compounds of the subformulae IIc, IId, IIe and IIf, in particular from the group consisting of IIc and IIe.

Preference is furthermore given to liquid-crystal media which comprise one or more compound(s) of the formula III selected from the group consisting of the subformulae IIIa to IIId.

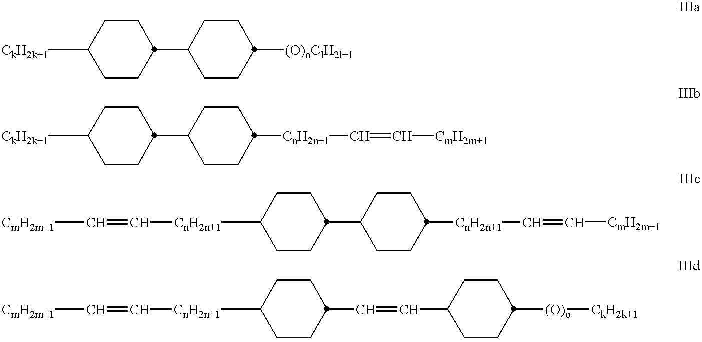

where, in each case independently of one another,

k and l are 1, 2, 3, 4 or 5,

m and n are 0, 1, 2 or 3, and

o is 0 or 1, but

m+n is ≦5.

Preference is furthermore given to liquid-crystal media which comprise one or more compound(s) of the formula IV selected from the group consisting of the subformulae IVa to IVr.

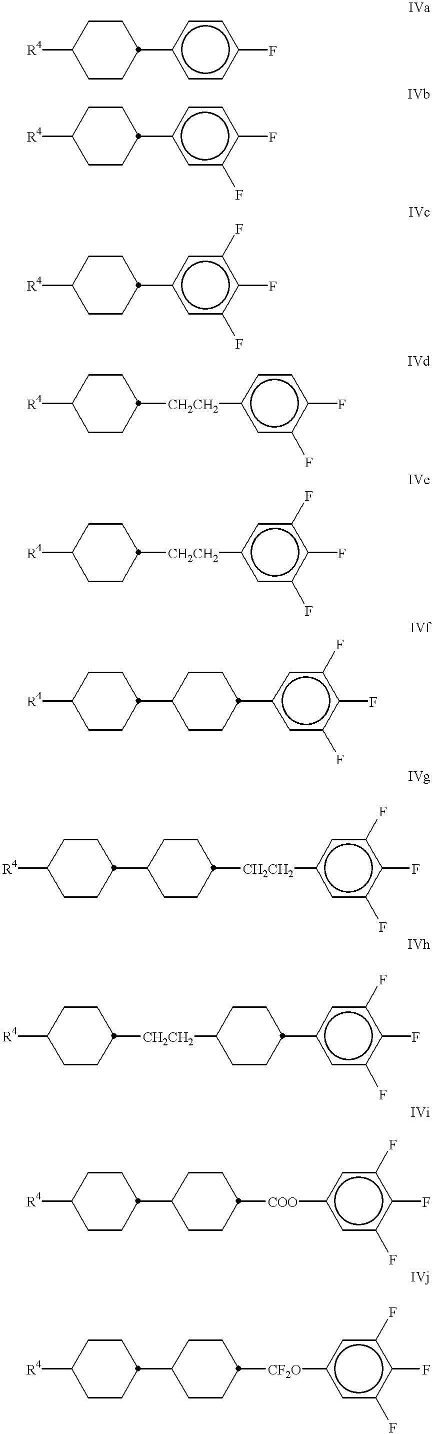

in which R⁴ is as defined above under formula IV.

In another preferred embodiment, the liquid-crystal media comprise one or more compound(s) of the formula IV selected from the group consisting of the subformulae IVs and IVt.

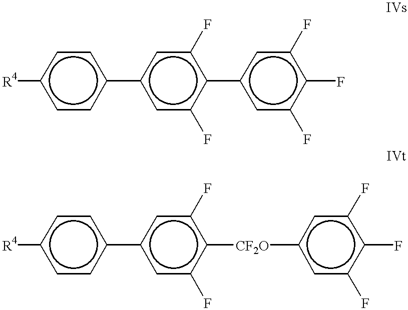

in which R⁴ is as defined above under formula IV.

The compounds selected from the group consisting of the compounds of the formulae IVs and IVt can be used in addition to or instead of the compounds selected from the group consisting of the compounds of the formulae IVa and IVr.

In another preferred embodiment, the liquid-crystal media comprise one or more compound(s) of the subformula I-1a and/or I-2a, the concentration of each of these compounds being in the range from 0.1 to 20%, preferably from 1 to 16%, particularly preferably from 2 to 12%, very particularly preferably from 3 to 10%.

In a preferred embodiment of the invention, the liquid-crystal media comprise one or more compounds of the formula I-1a and/or I-2a, the concentration of each of these compounds being from 0.1 to 18%, preferably from 1 to 14%, particularly preferably from 2 to 10%.

Preferred embodiments are liquaid-crystal media which meet one or more, preferably two or more, of the following conditions.

The medium additionally comprises

one or more compounds selected from the group of the formulae Va and Vb

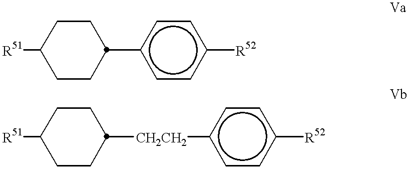

in which R⁵¹ and R⁵² are each, independently of one another, alkyl or alkoxy having 1 to 7 carbon atoms or alkenyl, alkenyloxy or alkoxyalkyl having 2 to 7 carbon atoms, R⁵¹ preferably being alkyl having 1 to 5 carbon atoms, R⁵² preferably being alkyl or alkoxy, in parituclar alkoxy, having 1 to 3 carbon atoms,

one or more compound(s) selected from the group of the formulae Vc and Vd

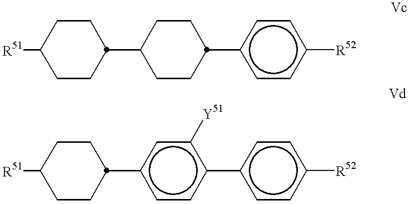

in which

R⁵¹ and R⁵² independently of one another, are as defined above, R⁵¹ preferably being n-alkyl having 3 to 5 carbon atoms, and R⁵² preferably being n-alkyl, and

Y⁵¹ is H or F;

one or more compound(s) selected from the group of the formulae Ve to Vh, preferably Ve and/or Vf

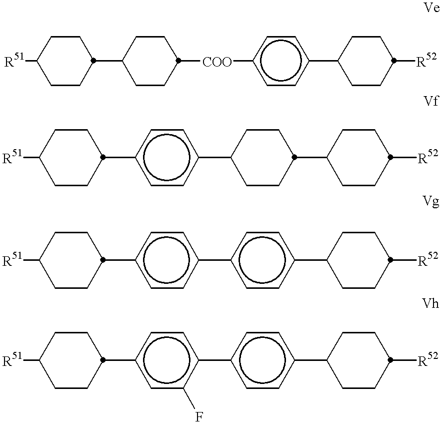

in which

R⁵¹ and R⁵² are each, independently of one another, as defined above, and are preferably n-alkyl having 3 to 5 carbon atoms.

Particular preference is given to liquid-crystal media comprising

one or more compound(s) of the formula Va in which, preferably, at least one of the groups R⁵¹ and R⁵² is alkenyl, preferably 1E-alkenyl, particularly preferably vinyl or 1E-propenyl,

one or more compound(s) of the formula Vb in which, preferably,

R⁵¹ is n-alkyl having 3 to 5 carbon atoms, particularly preferably having 3 to 5 carbon atoms, and

R⁵² is alkoxy having 1 to 3 carbon atoms, particularly preferably having 1 carbon atom,

one or more compound(s) of the formula Vc in which

R⁵¹ is n-alkyl having 1 to 5 carbon atoms, preferably having 1 to 3 carbon atoms, and

R⁵² is 1E-alkenyl having 2 to 5 carbon atoms, preferably having 2 to 3 carbon atoms, and/or

one or more compound(s) of the formula Vd in which

R⁵¹ is n-alkyl having 1 to 5 carbon atoms, preferably having 1 to 3 carbon atoms,

R⁵² is n-alkyl having 1 to 5 carbon atoms, preferably having 2 to 4 carbon atoms, and

Y⁵¹ is preferably H.

The liquid-crystalline medium according to the invention preferably comprises at least one compound of the formula I, and at least one compound selected from the group consisting of the compounds of the formulae IIa to IIf and IIIa to IIId, and at least one compound selected from the group consisting of the compounds of the formulae IVa and IVr.

The liquid-crystalline medium according to the invention particularly preferably comprises, in total,

from 2 to 40, preferably from 3 to 30, particularly preferably from 3 to 20, % by weight of at least one compound of the formula I, preferably of the formula I-1a and/or I-2a,

from 3 to 25, preferably from 5 to 19, % by weight of at least one compound of the formula II, preferably selected from the group consisting of the compounds of the formulae IIa and IIe,

from 3 to 30, preferably from 5 to 25, % by weight of at least one compound of the formula III, preferably selected from the group consisting of the compounds of the subformulae IIIa to IIIc,

from 15 to 65, preferably from 35 to 55, % by weight of at least one compound of the formula IV, preferably selected from the group consisting of the compounds of the subformulae IVa to IVc, IVf and IVi.

The liquid-crystalline media used in accordance with the invention generally have a birefringence (Δn) of <0.10, preferably <0.09, particularly preferably <0.08 and very particularly preferably <0.07. Preferably Δn is in the range from 0.045 to 0.095, in particular in the range from 0.055 to 0.085, and very particularly preferably in the range from 0.065 to 0.075. The media have clearing points of 70 to 90° C., the smaller birefringence values, i.e. both the narrower ranges and the smaller values within the respective ranges, being preferred for those media having lower clearing points.

The flow viscosity (at 20° C.) of the mixtures used in accordance with the invention is generally less than 30 mm²·s⁻¹, in particular from 15 to 25 mm²·s⁻¹. The resistivity of the materials according to the invention at 20° C. is in the range from 5×10¹⁰ to 5×10¹³ Ω·cm, particularly preferably in the range from 5×10¹¹ to 5×10¹² Ω·cm. The rotational viscosity of the mixtures according to the invention at 20° C. is generally less than 130 mPa·s, preferably less than 120 mPa·s, and is in particular in the range from 60 to 115 mPa·s and preferably in the range from 75 to 110 mPa·s.

Media used in accordance with the invention having clearing points of from 70 to 80° C. have rotational viscosities of 125 mPa·s or less, preferably of from 70 to 100 mPa·s.

The clearing point of the media used in accordance with the invention is above 60° C., preferably 70° C. or more and particularly preferably 80° C. or more. In particular, the clearing point is in the range from 60° C. to 80° C. The storage stability in test cells, determined as described below, is 1000 hours or more at −30° C., preferably 500 hours or more at −40° C., very particularly preferably 1000 hours or more at −40° C.

The media used in accordance with the invention consist of from 5 to 30 compounds, preferably from 6 to 20 compounds, particularly preferably from 7 to 16 compounds.

It has been found that even a relatively small proportion of compounds of the formula I mixed with conventional liquid-crystal materials, but in particular with one or more compounds selected from the group consisting of the compounds of the formulae IIa to IIf and/or from the group consisting of the compounds of the formulae IIIa to IIId and/or IVa to IVr, results in a significant reduction in the threshold voltage, in favorable values for the rotational viscosity γ₁ and in fast response times, in particular broad nematic phases having low smectic-nematic transition temperatures being observed. The invention furthermore relates to an electro-optical liquid-crystal display containing a liquid-crystal medium of positive dielectric anisotropy according to the invention.

Particular preference is given to a liquid-crystal display according to the invention in which the pixels are addressed by means of a matrix of active (non-linear) electrical switches.

The liquid-crystal display according to the invention is very particularly preferably an IPS display.

The compounds of the formulae I to IV are colorless, stable and readily miscible with one another and with other liquid-crystal materials.

The term “alkyl” encompasses straight-chain and branched alkyl groups having 1-7 carbon atoms, in particular the straight-chain groups methyl, ethyl, propyl, butyl, pentyl, hexyl and heptyl. Groups having 2-5 carbon atoms are preferred, unless explicitly stated otherwise.

The term “alkenyl” encompasses straight-chain and branched alkenyl groups having 2-7 carbon atoms, in particular the straight-chain groups. Particularly preferred alkenyl groups are C₂-C₇-1E-alkenyl, C₄-C₇-3E-alkenyl, C₅-C₇-4-alkenyl, C₆-C₇-5-alkenyl and C₇-6-alkenyl, in particular C₂-C₇-1E-alkenyl, C₄-C₇-3E-alkenyl and C₅-C₇-4-alkenyl. Examples of very particularly preferred alkenyl groups are vinyl, 1E-propenyl, 1E-butenyl, 1E-pentenyl, 1E-hexenyl, 1E-heptenyl, 3E-butenyl, 3E-pentenyl, 3E-hexenyl, 3E-heptenyl, 4-pentenyl, 4Z-hexenyl, 4E-hexenyl, 4Z-heptenyl, 5-hexenyl, 6-heptenyl and the like. Groups having up to 5 carbon atoms are preferred, unless explicitly stated otherwise.

The term “fluoroalkyl” preferably encompasses straight-chain groups containing terminal fluorine, i.e. fluoromethyl, 2-fluoroethyl, 3-fluoropropyl, 4-fluorobutyl, 5-fluoropentyl, 6-fluorohexyl and 7-fluoroheptyl. However, other positions of fluorine are not excluded.

The term “alkoxyalkyl” preferably encompasses straight-chain radicals of the formula CₙH₂ₙ₊₁—O—(CH₂)ₘ, in which n and m are each, independently of one another, from 1 to 6. m is preferably 1 and n is preferably from 1 to 4.

A suitable choice of the meanings of R¹ to R⁵² allows the response times, the threshold voltage, the steepness of the transmission characteristic lines etc. to be modified as desired. For example, 1E-alkenyl radicals, 3E-alkenyl radicals, 2E-alkenyloxy radicals and the like generally result in shorter response times, improved nematic tendencies and a higher ratio of the elastic constants k₃₃ (bend) and k₁₁ (splay) compared with alkyl or alkoxy radicals. 4-Alkenyl radicals, 3-alkenyl radicals and the like generally result in lower threshold voltages and smaller values of k₃₃/k₁₁ compared with alkyl and alkoxy radicals.

The optimum weight ratio of the compounds of the formulae I-IV depends substantially on the desired properties, on the choice of the components of the formulae I, II, III and/or IV, and on the choice of any other components which may be present. Suitable weight ratios within the range given above can easily be determined from case to case.

The total amount of compounds of the formulae I to IV in the mixtures used according to the invention is not critical. The mixtures preferably comprise 50-90% by weight of compounds of the formulae I to IV. The mixtures may also comprise one or more further components in order to optimize various properties. However, the observed effect, particularly on the threshold voltage and the rotational viscosity, is generally greater the higher the total concentration of compounds of the formulae I to IV, in particular of the formula I.

In a particularly preferred embodiment, the media according to the invention comprise compounds of the formula IV in which X is OCF₃. A favorable synergistic effect with the compounds of the formulae I and II results in particularly advantageous properties.

In addition to one or more compound(s) of the formula I, the liquid-crystalline media according to the invention preferably comprise from 2 to 40, in particular from 4 to 30, compounds as further constituents. These media very particularly preferably comprise from 7 to 15 compounds in addition to one or more compound(s) of the formula I. These further constituents are preferably selected from nematic or nematogenic (monotropic or isotropic) substances, in particular substances from the classes of the azoxybenzenes, benzylideneanilines, biphenyls, terphenyls, phenyl or cyclohexyl benzoates, phenyl or cyclohexyl esters of cyclohexanecarboxylic acid, phenyl or cyclohexyl esters of cyclohexylbenzoic acid, phenyl or cyclohexyl esters of cyclohexylcyclohexanecarboxylic acid, cyclohexylphenyl esters of benzoic acid, of cyclohexanecarboxylic acid and of cyclohexylcyclohexanecarboxylic acid, phenylcyclohexanes, cyclohexylbiphenyls, phenylcyclohexylcyclohexanes, cyclohexylcyclohexanes, cyclohexylcyclohexylcyclohexenes, 1,4-bis-cyclohexylbenzenes, 4,4′-bis-cyclohexylbiphenyls, phenyl- or cyclohexylpyrimidines, phenyl- or cyclohexylpyridines, phenyl- or cyclohexyldioxanes, phenyl- or cyclohexyl-1,3-dithianes, 1,2-diphenylethanes, 1,2-dicyclohexylethanes, 1-phenyl-2-cyclohexylethanes, 1-cyclohexyl-2-(4-phenylcyclohexyl)ethanes, 1-cyclohexyl-2-biphenylylethanes, 1-phenyl-2-cyclohexylphenylethanes, optionally halogenated stilbenes, benzyl phenyl ethers, tolans and substituted cinnamic acids. The 1,4-phenylene groups in these compounds may also be fluorinated.

The most important compounds suitable as further constituents of media used according to the invention can be characterized by the formulae 1, 2, 3, 4 and 5:

R′-L-E-R″ 1

R′-L-COO-E-R″ 2

R′-L-OOC-E-R″ 3

R′-L-CH₂CH₂-E-R″ 4

R′-L-C≡C-E-R″ 5

In the formulae 1, 2, 3, 4 and 5, L and E, which may be identical or different, are in each case, independently of one another, a bivalent radical from the group consisting of -Phe-, -Cyc-, -Phe-Phe-, -Phe-Cyc-, -Cyc-Cyc-, -Pyr-, -Dio-, -G-Phe- and -G-Cyc- and their mirror images, where Phe is unsubstituted or fluorine-substituted 1,4-phenylene, Cyc is trans-1,4-cyclohexylene or 1,4-cyclohexylene, Pyr is pyrimidine-2,5-diyl or pyridine-2,5-diyl, Dio is 1,3-dioxane-2,5-diyl and G is 2-(trans-1,4-cyclohexyl)ethyl, pyrimidine-2,5-diyl, pyridine-2,5-diyl or 1,3-dioxane-2,5-diyl.

One of the radicals L and E is preferably Cyc, Phe or Pyr. E is preferably Cyc, Phe or Phe-Cyc. The media according to the invention preferably comprise one or more components selected from the compounds of the formulae 1, 2, 3, 4 and 5 in which L and E are selected from the group consisting of Cyc, Phe and Pyr and simultaneously one or more components selected from the compounds of the formulae 1, 2, 3, 4 and 5 in which one of the radicals L and E is selected from the group consisting of Cyc, Phe and Pyr and the other radical is selected from the group consisting of -Phe-Phe-, -Phe-Cyc-, -Cyc-Cyc-, -G-Phe- and -G-Cyc-, and optionally one or more components selected from the compounds of the formulae 1, 2, 3, 4 and 5 in which the radicals L and E are selected from the group consisting of -Phe-Cyc-, -Cyc-Cyc-, -G-Phe- and -G-Cyc-.

In a smaller subgroup of the compounds of the formulae 1, 2, 3, 4 and 5, R′ and R″ are each, independently of one another, alkyl, alkenyl, alkoxy, alkoxyalkyl, alkenyloxy or alkanoyloxy having up to 8 carbon atoms. This smaller subgroup is called Group A below, and the compounds are denoted by the subformulae 1a, 2a, 3a, 4a and 5a. In most of these compounds, R′ and R″ are different from one another, one of these radicals usually being alkyl, alkenyl, alkoxy or alkoxyalkyl.

In another smaller subgroup of the compounds of the formulae 1, 2, 3, 4 and 5 which is called Group B, R″ is —F, —Cl, —NCS or —(O)ᵢCH₃₋₍ₖ₊₁₎FₖCl₁, where i is 0 or 1, and k+1 is 1, 2 or 3; the compounds in which R″ has this meaning are denoted by the subformulae 1b, 2b, 3b, 4b and 5b. Particular preference is given to those compounds of the subformulae 1b, 2b, 3b, 4b and 5b in which R″ is —F, —Cl, —NCS, —CF₃, —OCHF₂ or —OCF₃.

In the compounds of the subformulae 1b, 2b, 3b, 4b and 5b, R′ is as defined for the compounds of the subformulae 1a-5a and is preferably alkyl, alkenyl, alkoxy or alkoxyalkyl.

In a further smaller subgroup of the compounds of the formulae 1, 2, 3, 4 and 5, R″ is —CN; this subgroup is called Group C below, and the compounds of this subgroup are correspondingly described by subformulae 1c, 2c, 3c, 4c and 5c. In the compounds of the subformulae 1c, 2c, 3c, 4c and 5c, R′ is as defined for the compounds of the subformulae 1a-5a and is preferably alkyl, alkoxy or alkenyl.

In addition to the preferred compounds from Groups A, B and C, other compounds of the formulae 1, 2, 3, 4 and 5 having other variants of the proposed substituents are also customary. All these substances can be obtained by methods which are known from the literature or analogously thereto.

In addition to the compounds of the formulae I to IV, the media used according to the invention preferably comprise one or more compounds selected from Group A and/or Group B and/or Group C. The proportions by weight of the compounds from these groups in the media according to the invention are preferably

Group A: from 0 to 90%, preferably from 20 to 90%, in particular from 30 to 90%

Group B: from 0 to 80%, preferably from 10 to 80%, in particular from 10 to 65%

Group C: from 0 to 80%, preferably from 5 to 80%, in particular from 5 to 50%,

the sum of the proportions by weight of the Group A and/or B and/or C compounds present in the particular media used according to the invention preferably being from 5% to 90% and in particular from 10% to 90%.

The media used according to the invention preferably comprise from 1% to 40%, particularly preferably from 5% to 30%, and very particularly preferably from 8% to 25%, of compounds of the formula I. The media preferably comprise two or more compounds of the formula I.

The media used according to the invention preferably comprise, in total, 70% or more, particularly preferably 80% or more, and very particularly preferably 90% or more, of compounds of the formulae I to IV.

The media preferably comprise two or more compounds of the formula I.

The construction of the IPS displays according to the invention corresponds to the usual design of displays of this type, as described, for example, in WO 91/10936 or EP 0 588 568. The term “conventional design” is broadly drawn here and also covers all variations and modifications of the IPS display, in particular, for example, also matrix display elements based on poly-Si TFT or MIM.

However, an essential difference between the displays according to the invention and the conventional displays lies in the choice of the composition and the parameters of the liquid-crystal layer.

The liquid-crystal mixtures which are used in accordance with the invention are prepared in a manner which is customary per se. In general, the desired amount of the components used in the smaller amount is dissolved in the components making up the principal constituent, advantageously at elevated temperature. It is also possible to prepare the mixtures in other conventional manners, for example by using pre-mixtures, for example mixtures of homologues, or using so-called “multi-bottle” systems which, for example, consist of four basic mixtures which differ significantly from one another in only one physical property in each case.

The dielectrics may also comprise further additives known to the person skilled in the art and described in the literature. For example, 0-10%, preferably 0-8%, of pleochroic dyes and/or chiral dopants can be added. The individual compounds added are employed in concentrations of from 0.01 to 6%, preferably from 0.1 to 3%. However, the concentrations of the other constituents of the liquid-crystal mixtures, i.e. the liquid-crystalline or mesogenic compounds, are given without taking into account the concentration of these additives.

Above and below,

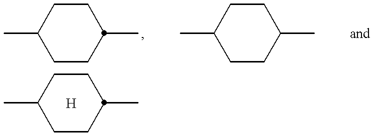

are trans-1,4-cyclohexylene.

The physical properties of the liquid-crystal mixtures are determined as described in “Physical Properties of Liquid Crystals”, Ed. W. Becker, Merck KGaA, status November 1997, unless explicitly stated otherwise.

C denotes a crystalline phase, S a smectic phase, S_{C} a smectic C phase, S_{A} a smectic A phase, N a nematic phase and I the isotropic phase. V₀ denotes the capacitive threshold voltage. Δn denotes the optical anisotropy and n₀ the ordinary refractive index (in each case at 589 nm). Δε denotes the dielectric anisotropy (Δε=ε_{∥}−ε_{⊥}, where ε_{∥} denotes the dielectric constant parallel to the longitudinal molecular axes and ε_{⊥} denotes the dielectric constant perpendicular thereto, in each case at 1 kHz). The electro-optical data were measured in a planar cell at 20° C., unless expressly stated otherwise. All physical properties are quoted and measured at 20° C., unless expressly stated otherwise. The cells are preferably bright in the “off” state.

Without further elaboration, it is believed that one skilled in the arta can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degree Celsius; and, unless otherwise indicated, all parts and percentages are by weight.

The entire disclosure of all applications, patents and publications, cited above or below, and of corresponding German Application No. 10025884.0, filed May 25, 2000 is hereby incorporated by reference.

Δn denotes the optical anisotropy (589 nm, 20° C.), Δε denotes the dielectric anisotropy (1 kHz, 20° C.), H.R. denotes the voltage holding ratio (at 100° C., after 5 minutes in an oven at 1 V), and V₀, the capacitive threshold voltage, was determined at 20° C. and 1 kHz.

The calibrated rotational viscometer gave a rotational viscosity for ZLI-4792 (Merck KGaA) of 133 mPa·s at 20° C.

The storage stability was investigated in sealed test cells with an optical retardation of about 0.5 μm using CU-1511 from DuPont, USA, as alignment layer. To this end, in each case 5 test cells were adhesively bonded on both sides to crossed polarizers and stored at fixed temperatures of 0° C., −10° C., −20° C., −30° C. or −40° C. The cells were assessed visually for changes at intervals of 24 hours in each case. The storage time at the respective temperature tₛₜₒᵣₑ (T) was noted as the final time at which no change was observed in any of the cells.

In the present application and in the following examples, the structures of the liquid-crystal compounds are specified by acronyms, which can be transformed into chemical formulae according to the following Tables A and B. All radicals CₙH₂ₙ₊₁ are straight-chain alkyl radicals having n or m carbon atoms. The coding according to Table B is self-evident. Table A specifies the acronym for the parent body only. In individual cases, the acronym for the parent body is followed, separated therefrom by a hyphen, by a code for the substituents R¹, R², L¹ and L²:

| Code for R¹, | | | | |
|---|---|---|---|---|
| R², L¹, L² | R¹ | R² | L¹ | L² |
| nm | CₙH₂ₙ₊₁ | CₘH₂ₘ₊₁ | H | H |
| nOm | CₙH₂ₙ₊₁ | OcₘH₂ₘ₊₁ | H | H |
| nO.m | OCₙH_{2n +1} | CₘH₂ₘ₊₁ | H | H |
| n | CₙH₂ₙ₊₁ | CN | H | H |
| nN.F | CₙH₂ₙ₊₁ | CN | F | H |
| nN.F.F | CₙH₂ₙ₊₁ | CN | F | F |
| nF | CₙH₂ₙ₊₁ | F | H | H |
| nF.F | CₙH₂ₙ₊₁ | F | F | H |
| nF.F.F | CₙH₂ₙ₊₁ | F | F | F |
| nOF | OCₙH₂ₙ₊₁ | F | H | H |
| nCl | CₙH₂ₙ₊₁ | Cl | H | H |
| nCl.F | CₙH₂ₙ₊₁ | Cl | F | H |
| nCl.F.F | CₙH₂ₙ₊₁ | Cl | F | F |
| nCF₃ | CₙH₂ₙ₊₁ | CF₃ | H | H |
| nCF₃.F | CₙH₂ₙ₊₁ | CF₃ | F | H |
| nCF₃.F,F | CₙH₂ₙ₊₁ | CF₃ | F | F |
| nOCF₃ | CₙH₂ₙ₊₁ | OCF₃ | H | H |
| nOCF₃.F | CₙH₂ₙ₊₁ | OCF₃ | F | H |
| nOCF₃.F.F | CₙH₂ₙ₊₁ | OCF₃ | F | F |
| nOCF₂ | CₙH₂ₙ₊₁ | OCHF₂ | H | H |
| nOCF₂.F | CₙH₂ₙ₊₁ | OCHF₂ | F | H |
| nOCF₂.F.F | CₙH₂ₙ₊₁ | OCHF₂ | F | F |
| nS | CₙH₂ₙ₊₁ | NCS | H | H |
| rVsN | CᵣH₂ᵣ₊₁—CH═CH—CₛH₂ₛ— | CN | H | H |
| rEsN | CᵣH₂ₙ₊₁—O—C₂H₂ₛ— | CN | H | H |
| nAm | CₙH₂ₙ₊₁ | C≡C—CₘH₂ₘ₊₁ | H | H |

TABLE A

| | |
|---|---|
| 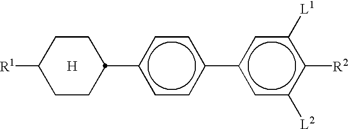 | 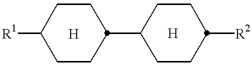 |
| BCH | CCH |
| 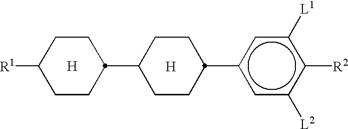 | 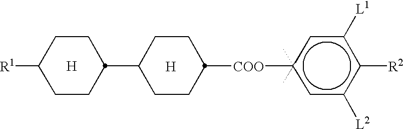 |
| CCP | CP |
| | 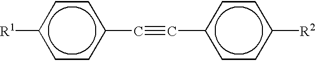 |
| | PTP |
| 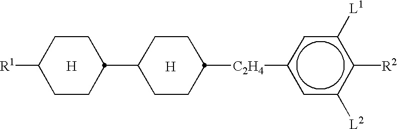 | 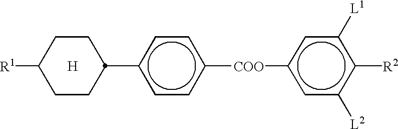 |
| ECCP | HP |
| 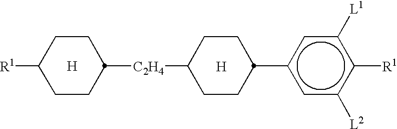 | |
| CECP | |
| 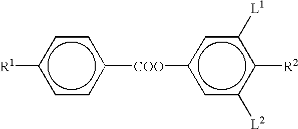 | 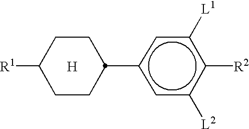 |
| ME | PCH |
| 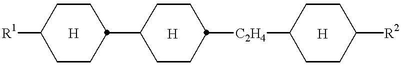 | 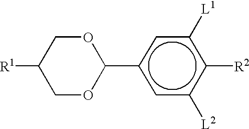 |
| CH | PDX |
| 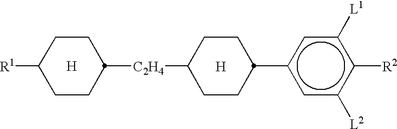 | |
| BECH | |
| 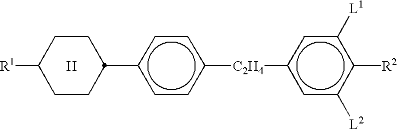 | 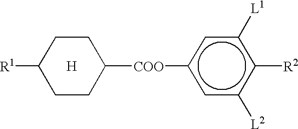 |
| EBCH | D |

TABLE B

| | |
|---|---|
| 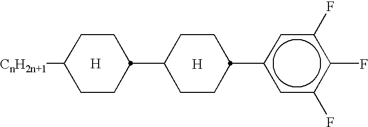 | 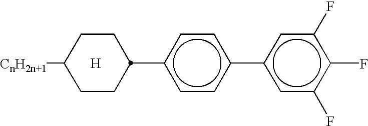 |
| CCP-nF.F.F | BCH-nF.F.F |
| 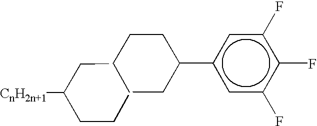 | 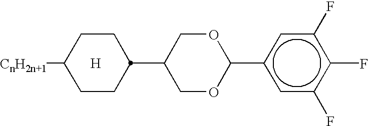 |
| DHP-nF.F.F | CDU-n-F |
| 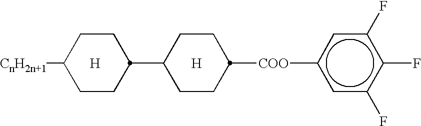 | 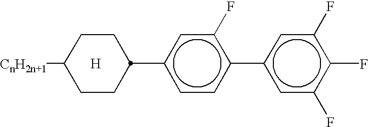 |
| CCZU-n-F | CGU-n-F |
| 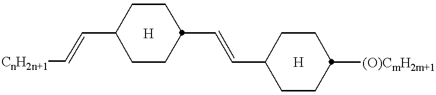 | 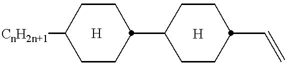 |
| CVCP-nV-(O)m | CC-n-V |
| 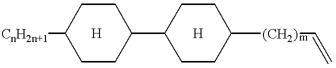 | 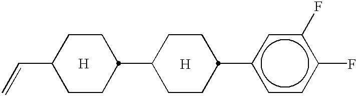 |
| CC-n-mV | CCG-V-F |
| 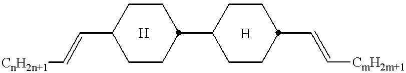 | 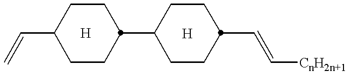 |
| CC-nV-Vm | CC-V-Vn |
| 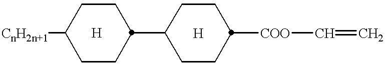 | |
| CC-n-ZV | |
| 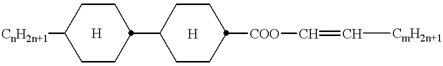 | |
| CC-n-ZVm | |
| 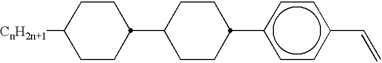 | 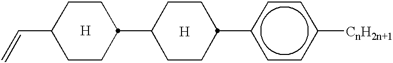 |
| CCP-n-V | CCP-V-n |
| 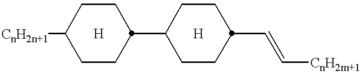 | |
| CC-n-Vm | |
| 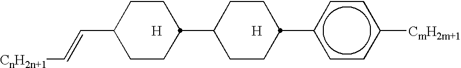 | |
| CCP-nV-m | |
| 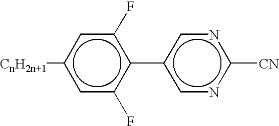 | 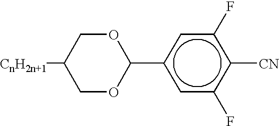 |
| UM-n-N | DU-n-N |

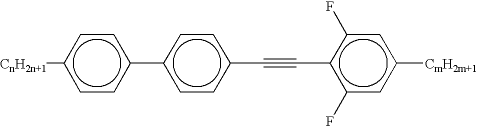

PPTUI-n-m

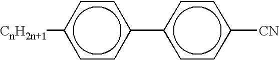

K3 n

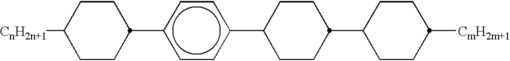

CPCC-nm

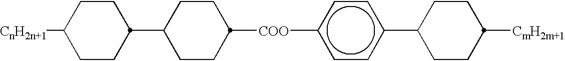

CCPC-nm

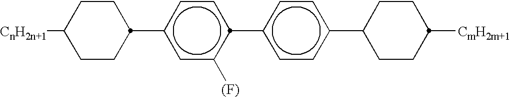

CBC-nm(F)

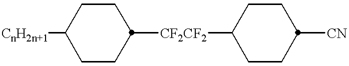

C—CF₂CF₂—C-n-N

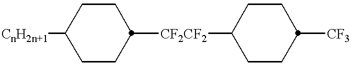

C—CF₂CF₂—C-n-T

Preferred displays contain media comprising, in particular, one or more compounds from Tables A and B in addition to the compounds of the formula I.

Particularly preferred IPS displays contain media comprising

one or more compounds of one of the formulae in Table A and one or more compounds of the formulae in Table B

one or more compounds of each of two or more different types of compounds of the formulae in Table A

one or more compounds of each of two or more different types of compounds of the formulae in Table B

one or more compounds of each of four or more compounds from the group consisting of the compounds of the formulae in Tables A and B.

### EXAMPLE 1

An IPS display contains a nematic mixture having

| Compound | Conc./ | |
|---|---|---|
| Abbreviation | % | Physical properties |
| C-CF2-CF2-C-3-N | 6.0 | T(N,I) = 72.0° C. |
| C-CF2-CF2-C-5-N | 2.0 | T(S,N) < −40° C. |
| PDX-3 | 9.0 | Δn (589 nm, 20° C.) = 0.0693 |
| PDX-5 | 2.0 | ε_{⊥} (1 kHz, 20° C.) = 4.4 |
| CCH-302 | 9.0 | Δε (1 kHz, 20° C.) = 9.4 |
| CC-3-V1 | 3.0 | γ₁ (20° C.) = 113 mPa · s |
| PCH-7F | 6.0 | |
| CCP-200F3 | 4.0 | V₀ (1 kHz, 20° C.) = 0.91 V |
| CCP-30CF3 | 9.0 | |
| CCP-50CF3 | 4.0 | |
| CCP-2F.F.F | 12.0 | |
| CCP-3F.F.F | 9.0 | |
| CCZU-2-F | 7.0 | |
| CCZU-3-F | 12.0 | |
| CCZU-5-F | 6.0 | |
| Σ | 100.0 | |

and has good contrast.

### COMPARATIVE EXAMPLE

An IPS display contains a nematic mixture having

| Compound | Conc./ | |
|---|---|---|
| Abbreviation | % | Physical properties |
| PDX-3 | 7.0 | T(N,I) = 70.8° C. |
| PDX-5 | 4.0 | T(S,N) < −30° C. |
| CCH-302 | 10.0 | Δn (589 nm, 20° C.) = 0.0700 |
| PCH-7F | 6.0 | ε_{⊥} (1 kHz, 20° C.) = 4.5 |
| CCP-20CF3 | 5.0 | Δε (1 kHz, 20° C.) = 9.4 |
| CCP-30CF3 | 8.0 | γ₁ (20° C.) = 119 mPa · s |
| CCP-50CF3 | 5.0 | |
| CCP-2F.F.F | 12.0 | V₀ (1 kHz, 20° C.) = 0.95 V |
| CCP-3F.F.F | 9.0 | |
| CCP-5F.F.F | 8.0 | |
| CCZU-2-F | 7.0 | |
| CCZU-3-F | 13.0 | |
| CCZU-5-F | 6.0 | |
| Σ | 100.0 | |

and has at best adequate contrast.

Directly compared to the liquid-crystal mixture of Example 1, which was adjusted to virtually the same application parameters, in particular clearing point and optical anisotropy, the Comparative Example has both a higher threshold and a higher rotational viscosity.

### EXAMPLE 2

An IPS display contains a nematic mixture having

| Compound | Conc./ | |
|---|---|---|
| Abbreviation | % | Physical properties |
| C-CF2-CF2-C-2-T | 8.0 | |
| PDX-3 | 9.0 | |
| PDX-5 | 2.0 | |
| CCH-302 | 9.0 | |
| CC-3-V1 | 3.0 | |
| PCH-7F | 6.0 | |
| CCP-20CF3 | 4.0 | |
| CCP-30CF3 | 9.0 | |
| CCP-50CF3 | 4.0 | |
| CCP-2F.F.F | 12.0 | |
| CCP-3F.F.F | 9.0 | |
| CCZU-2-F | 7.0 | |
| CCZU-3-F | 12.0 | |
| CCZU-5-F | 6.0 | |
| Σ | 100.0 | |

and has good contrast.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A liquid-crystalline medium of positive dielectric anisotropy, comprising one or more compound(s) of the formula I 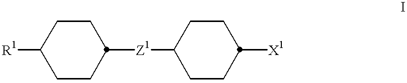
wherein
R¹ is alkyl or alkoxy having 1 to 7 carbon atoms or alkenyl, alkenyloxy or alkoxyalkyl having 2 to 7 carbon atoms,
Z¹ is CF₂—CF₂, CF₂—O, CH₂—CH₂, trans-CH═CH, trans-CF═CH, trans-CH═CF or trans-CF═CF, and
X¹ is F, Cl, CF₃, OCF₃, OCF₂H, CN or NCS.

2. A liquid-crystal medium according to claim 1, further comprising one or more compound(s) of the formula II: 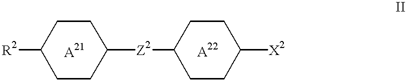
wherein
R² is alkyl or alkoxy having 1 to 7 carbon atoms or alkenyl, alkenyloxy or alkoxyalkyl having 2 to 7 carbon atoms, 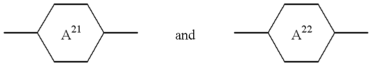
are each, independently of one another, 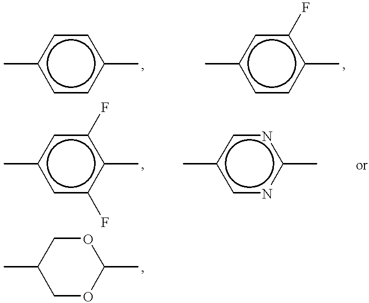
at least one of 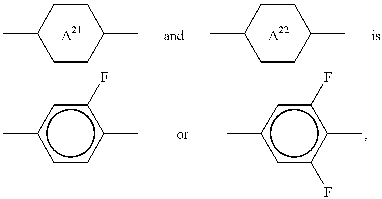
X² is F, Cl, CN or NCS, and
Z² is —CH₂CH₂—, —COO—, —CF₂O— or a single bond.

3. A liquid-crystal medium according to claim 1, further comprising at least one compound of the formula III 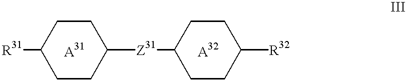
wherein
R³¹ and R³² are each, independently of one another, alkyl or alkoxy having 1 to 7 carbon atoms or alkenyl, alkenyloxy or alkoxyalkyl having 2 to 7 carbon atoms, 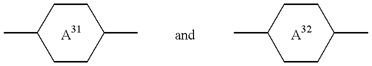
are each, independently of one another, 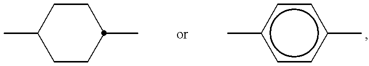
and
Z³¹ is —CH═CH—, —COO—, —CH₂CH₂— or a single bond.

4. A liquid-crystal medium according to claim 1, further comprising at least one compound of the formula IV 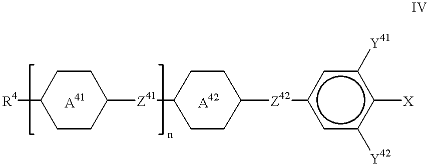
wherein
R⁴ is alkyl or alkoxy having 1 to 7 carbon atoms or alkenyl, alkenyloxy or alkoxyalkyl having 2 to 7 carbon atoms, 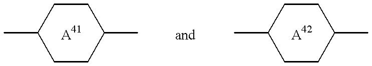
are each, independently of one another, 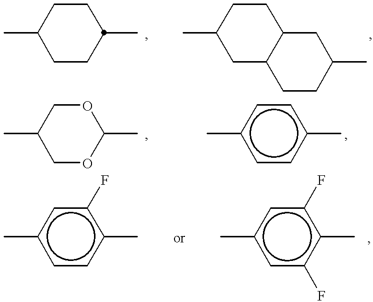
Z⁴¹ and Z⁴² are each, independently of one another, —CF₂O—, —COO—, —CH₂CH₂— or a single bond,
n is 0 or 1,
X is OCF₃, OCF₂H or F, and
Y⁴¹ and Y⁴² are each, independently of one another, H or F.

5. A liquid-crystal medium according to claim 1, further comprising one or more compounds of the formulae IIa to IIf: 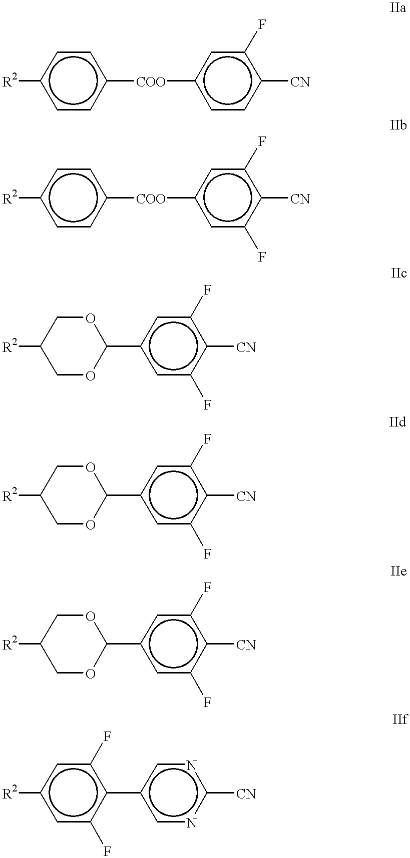
wherein R² is alkyl or alkoxy having 1 to 7 carbon atoms or alkenyl, alkenyloxy or alkoxyalkyl having 2 to 7 carbon atoms.

6. A liquid-crystal medium according to claim 1, further comprising one or more compounds of the formulae IIIa to IIId: 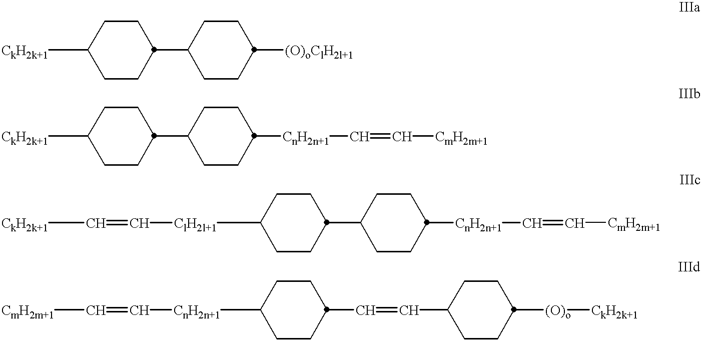
wherein, in each case independently of one another,
k and l are 1, 2, 3, 4 or 5,
m and n are 0, 1, 2 or 3, and
o is 0 or 1, with the proviso
m+n is <5.

7. A liquid-crystal medium according to claim 11, comprising
from about 1 to about 45% of one or more compound(s) of the formula I,
from about 2 to about 30% of one or more compound(s) of the formula II,
from about 2 to about 35% of one or more compound(s) of the formula III, and
from about 5 to about 70% by weight of two or more compounds of the formula IV.

8. A liquid-crystal display, comprising a liquid-crystal medium according to claim 1.

9. A liquid-crystal display according to claim 8, comprising pixels addressed by a matrix of active integrated electrical switches.

10. A liquid-crystal display comprising a medium according to claim 7.

11. A liquid crystal display according to claim 2, further comprising:
at least one compound of formula III: 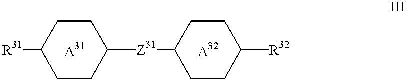
wherein
R³¹ and R³² are each, independently of one another, alkyl or alkoxy having 1 to 7 carbon atoms or alkenyl, alkenyloxy or alkoxyalkyl having 2 to 7 carbon atoms, 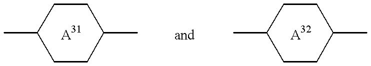
are each, independently of one another, 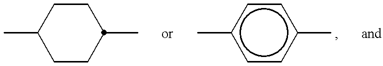
Z³¹ is —CH═CH—, —COO—, —CH₂CH₂— or a single bond; and
at least one compound of formula IV: 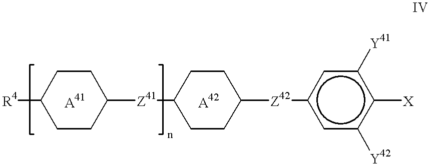
wherein
R⁴ is alkyl or alkoxy having 1 to 7 carbon atoms or alkenyl, alkenyloxy or alkoxyalkyl having 2 to 7 carbon atoms, 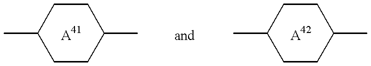
are each, independently of one another, 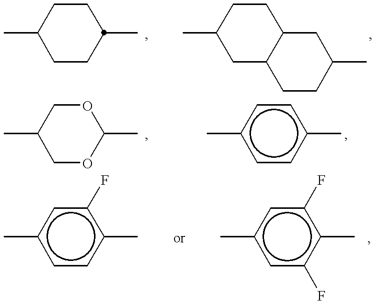
Z⁴¹ and Z⁴² are each, independently of one another, —CF₂O—, —COO—, —CH₂CH₂— or a single bond,
n is 0 or 1,
X is OCF₃, OCF₂H or F, and
Y⁴¹ and Y⁴² are each, independently of one another, H or F.
